(19) United States
(12) Patent Application Publication
(10) Pub. No.: US 2024/0119123 A1
(43) Pub. Date: Apr. 11, 2024

(54) DETERMINATION OF EVENT TYPES FROM AUTOENCODER-BASED UNSUPERVISED EVENT DETECTION

(71) Applicant: Dell Products L.P., Round Rock, TX (US)

(72) Inventors: Paulo Abelha Ferreira, Rio de Janeiro (BR); Vinicius Michel Gottin, Rio de Janeiro (BR); Herberth Birck Fröhlich, Florianópolis (BR)

(21) Appl. No.: 18/045,664

(22) Filed: Oct. 11, 2022

(51) Int. Cl. G06F 18/30; G06F 18/2413

(52) U.S. Cl. CPC G06F 18/30; G06F 18/24137

(57) ABSTRACT

Unsupervised event detection is disclosed. Reconstruction data resulting from processing input samples with a machine learning model is clustered. By labeling one or more samples of a cluster, all of the samples in the same cluster can be labeled the same. During inference, any input sample generating a similar reconstructed sample can be given the label previously applied to the cluster.

### FIELD OF THE INVENTION

Embodiments of the present invention generally relate to event detection and logistics operations. More particularly, at least some embodiments of the invention relate to systems, hardware, software, computer-readable media, and methods for automatically determining event types using unsupervised event detection.

### BACKGROUND

Detecting events in various types of environments can be performed using data generated in the environment. For example, mobile objects in various environments, such as warehouses, may be equipped with sensors of various types. Data from these sensors may be indicative of various types of events. Using an autoencoder trained on available data, the sensor data can be processed by the autoencoder to identify events of interest based on samples whose reconstructed samples exceed a predetermined threshold. In other words, the autoencoder may be trained with data representing normal or normative events. When an abnormal event occurs and the data is processed by the autoencoder, the output is associated with a reconstructed sample that may suggest an event of interest or a non-normative is occurring.

This is difficult, however, in unsupervised domains where there is no ground truth data for model training or model validation. In addition, in unsupervised domains, determining a threshold for the reconstructed sample is often impractical. More specifically, in unsupervised domains, reconstructed samples represent a magnitude of difference, but not contextual differences. Over time, even if multiple samples are identified as events of interest, no meaningful comparison between the samples or the events of interest can be performed.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of an autoencoder;

FIG. 1B discloses aspects of determining a reconstruction value, which may be represented as a vector;

FIG. 2A discloses aspects of an environment where models, such as autoencoders, can be deployed to nodes in the environment;

FIG. 2B discloses aspects of collecting or generating data at a node;

FIG. 2C discloses aspects of collecting reconstruction data or vectors;

FIG. 3 discloses aspects of labelling samples;

FIGS. 4A, 4B, and 4C discloses aspects of clustering and labeling reconstruction samples;

FIG. 5 discloses aspects of inference generation using clusters of reconstruction data; and

FIG. 6 discloses aspects of a computing device, system, or entity.

### DETAILED DESCRIPTION OF SOME EXAMPLE EMBODIMENTS

Embodiments of the present invention generally relate to logistics operations including event detection. More particularly, at least some embodiments of the invention relate to systems, hardware, software, computer-readable media, and methods for identifying contextually relevant sets of samples that are grouped as events of interest through reconstructed samples.

More specifically, a machine learning model such as an autoencoder may process data or data samples in an environment. Sensor data, for example, may be input to the autoencoder. The autoencoder may be configured to encode (e.g., compress) and then decode (e.g., decompress) the input data. The reconstructed or decoded data, which is output by the autoencoder, is associated with a reconstructed sample. The output data can be stored and clustered based, in part, on their reconstructed samples. More specifically, the reconstructed samples can be clustered. Because the reconstructed sample may be represented as a vector and clustered, candidate samples from each of the clusters can be presented to domain experts or other evaluators for labelling. This allows the categorization of sub-types of events with reduced human effort. When an evaluator determines that all candidate samples from a specific cluster should be labeled with the same label (or a sufficient portion or subset of the candidate samples), all samples in the cluster can be labeled with that same label. This allows the corresponding data samples to be labeled as well. When the autoencoder is deployed, a reconstructed sample from a new input data can, in effect, be mapped or placed to one of the clusters previously determined from historical data samples and then labeled accordingly.

In some embodiments, a self-supervision learning model (e.g., an autoencoder) is used to provide soft labels by grouping the samples into clusters with similar reconstructed sample vectors. There is no threshold for reconstructed samples in some examples. More specifically, the reconstructed sample samples, which are vectors in one example, and which are generated from the input data samples and the reconstructed output samples, are used to perform unsupervised clustering. The reconstructed sample samples or vectors may be periodically re-clustered to capture changes over time that may occur due to contextual differences of conceptual changes (e.g., drift) in time separated samples.

This approach advantageously allows a threshold value for event detection to be determined based on historical data rather than user expertise. As described herein, the threshold can be inferred from a cluster that is close to the origin of the cluster space.

One type of machine learning model is an encoder. An autoencoder is a deep neural network that learns to compress/decompress high-dimensional data using encoder/decoder layers. Autoencoders learn how to compress/decompress data using only information coming from the data in an unsupervised manner.

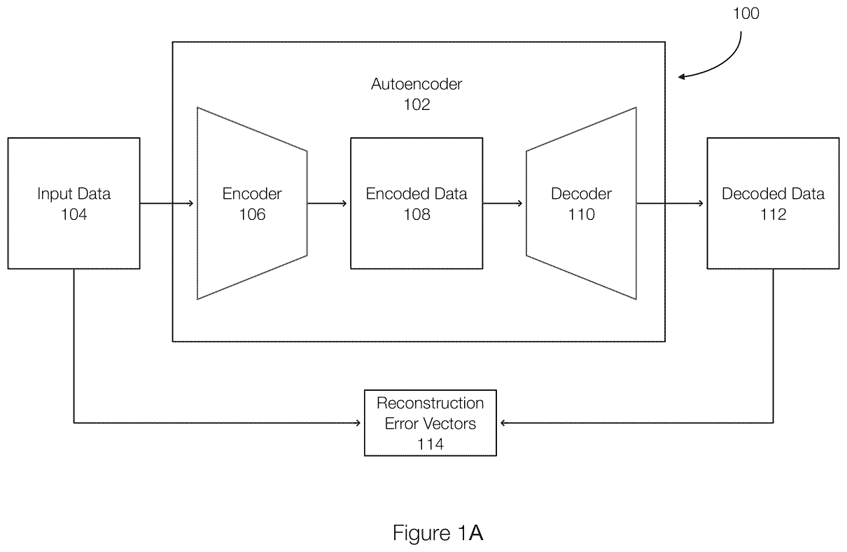

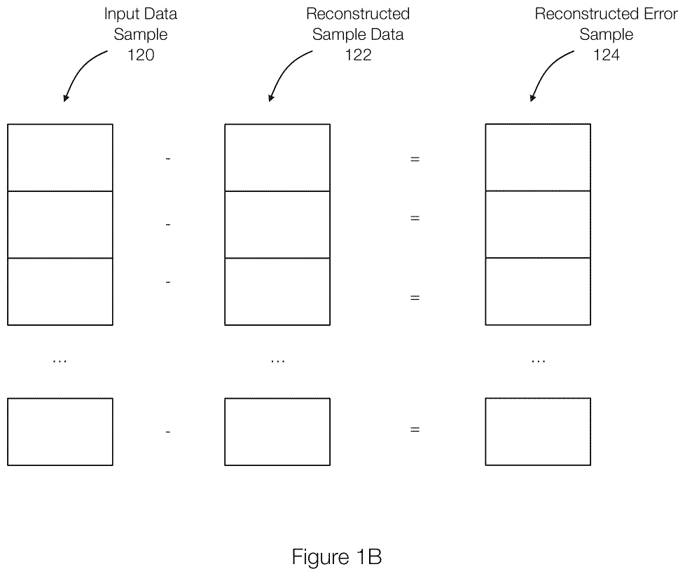

FIG. 1A discloses aspects of machine learning model. In one example, the model 100 is an autoencoder, represented by the autoencoder 102. In one example, the data set 104 (e.g., input events, input data samples or input data vectors) may be used to generate decoded data 112. The decoded data 112 is a reconstruction of the input data 104 and is an example reconstructed data, reconstructed samples, or reconstructed vectors. Reconstruction error vectors 114 are determined from the input data 104 and the decoded data 112 and may be referred to as reconstruction errors, reconstruction error vector samples, or the like.

More specifically, the autoencoder 102 is unsupervised in one example and learns to encode/decode data. In effect, the encoder 106 may compress the data 104 into compressed or encoded data 108. The decoder 110 operates to decompress or decode the encoded data 108. Ideally, the decoded data 112 is the same as the input data 104.

In one example, each input Xᵢ (input data 104 or a data sample) input into the encoder 102 results in a latent vector Zᵢ (encoded data 108) that, when passed through the decoder 110 generates a decompressed datum Xᵢ′ (the decoded data 112 or reconstructed sample). The encoder 106 may be represented as f_{θ}_{ₑ}(x) and the decoder 110 may be represented as f_{θ}_{_{d}}(z). In this formulation, θ represents or determines the parameterization where θₑ refers to the encoding parameters and θ_{d} refers to the decoding parameters.

FIG. 1B discloses additional aspects of an autoencoder and a reconstructed sample. In this example, the input data sample 120 may be input to the autoencoder 102 and the autoencoder 102 outputs a reconstructed data sample 122. The difference between the input data sample 120 and the reconstructed data sample 122 is an example of a reconstructed sample 124. In one example, the input data sample 120 and the reconstructed data sample 122 have the same dimensionality and the reconstructed sample 124 or vector may be computed as an element wise absolute difference.

Thus, when d is a difference or absolute difference, the error E is:

E=Σⱼ₌₀ⁿd(Xᵢ[j],Xᵢ′[j])=Σⱼ₌₀ⁿRᵢ[j].

Generally, the reconstructed sample or a particular sample can be compared to a threshold value. If the reconstructed sample is higher than the threshold value, the input data sample 120 may constitute or correspond to an anomalous event. However, in an unsupervised domain, this cannot be confirmed without human intervention, which is expensive and unfeasible on a typical volume of data from a real edge environment. Embodiments of the invention are advantageously able to identify contextually relevant sets of samples using the reconstructed samples without human intervention.

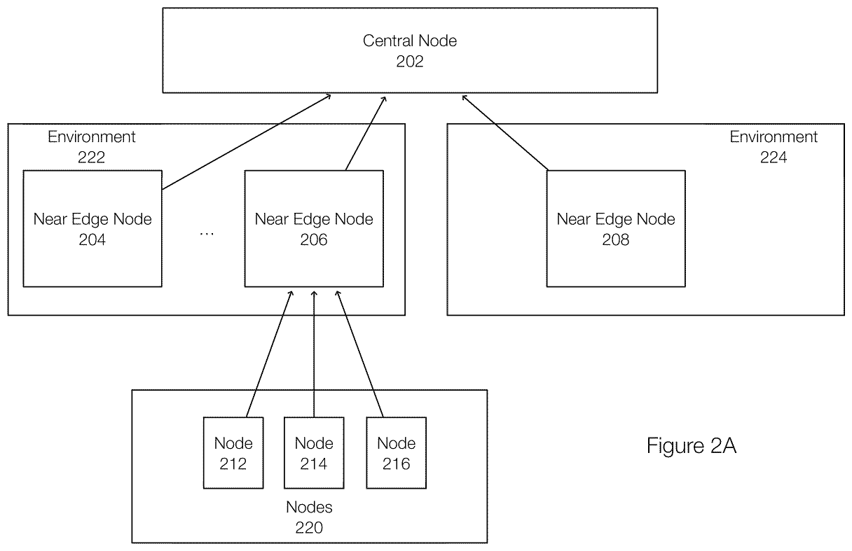

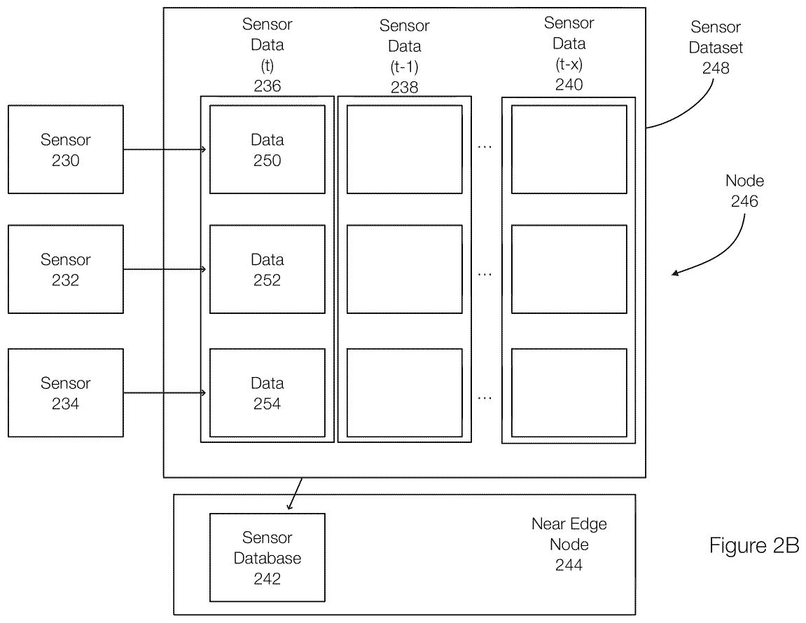

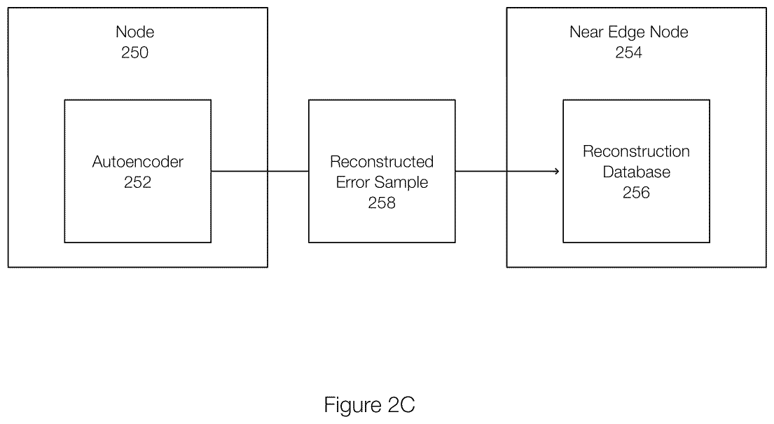

FIG. 2A discloses aspects of environments in which models (autoencoders) are deployed to nodes in the environment. FIG. 2A illustrates an environment 222 and an environment 224. The environments 222 and 224 may be warehouses, factories, stores, or the like. The environments 222 and 224 may be associated with the same entity or with different entities. The environment 222 is associated with at least one near edge-node, represented by a near edge node 204 and a near edge node 206. The environment 224 includes near edge node 208.

Each of the near edge nodes may be associated with a group or set of nodes (objects in the environment). The near edge node 206 is associated with nodes 220, which includes the nodes 212, 214, and 216. These nodes 220 are examples of far-edge nodes. Generally, the near edge node 206 includes more powerful computing resources than the computing resources of the nodes 220.

A central node 202 may also be included or available. The central node 202 may operate in the cloud and may communicate with multiple near edge nodes associated with multiple environments. However, the central node 202 may not be necessary. Thus, the near edge node 206 may be a central node from the perspective of the nodes 220. Alternatively, the nodes 220 may communicate directly with the central node 202.

FIG. 2B discloses aspects of data generated at or collected from a node. The node 246 (an example of the nodes 220) may include or be associated with sensors 230, 232, and 234. The sensors 230, 232, and 234 may include inertial sensors, position sensors, load sensors, direction sensors, proximity sensors, or the like or combinations thereof. These sensors 230, 232, and 234 generate, respectively, data 250, 252, and 254.

In one example, data is generated as collections 236, 238, and 240. Thus, the collection 236 is a set of sensor data generated or collected at time t. The sensor data 238 was collected at time t−1 and the sensor data 240 was collected at time t-x. The sensor dataset 248, which includes one or more collections, may be stored at least temporarily at the node 246 and is transmitted to the near edge node 244 and stored in a sensor database 242. The sensor dataset 248 may be limited to x collections in some embodiments. The sensor database 242 may store sensor data from multiple nodes in an environment. The sensor database 242 may store data for longer periods of time. The data collected by the nodes in an environment may be stored in the sensor database 242. The data stored in the sensor database 242 may be used in embodiments of the invention. Data stored locally at the nodes may be used with regard to autoencoders at the nodes themselves.

In one example, each collection may be an example of a data sample. Alternatively, data output by each sensor may be an example of a data sample. IN one example, an autoencoder may process collections. More specifically, features from the sensor data are input to the autoencoder as an input sample. The input sample is an n dimensional vector. As a result, the output data sample (the reconstructed data) and the reconstruction error sample are also n dimensional vectors.

FIG. 2C discloses aspects of collecting reconstructed sample samples. In FIG. 2C, an autoencoder 252 operates at a node 250. A reconstructed sample 258 generated from the autoencoder 252 (or from the input/output of the autoencoder 252) may be transmitted to the reconstruction database 256 at a near edge node 254. The reconstruction database 256 may store reconstructed samples received from other nodes in the environment. A central node may store reconstructed samples from multiple near edge nodes. Generally, the environments associated with these reconstruction databases are homogenous with respect to events. For example, multiple warehouses may be associated with a logistics domain. Forklifts or autonomous robots may operate in each of these environments. Thus, events such as trajectories or collisions are homogenous across each of these warehouses.

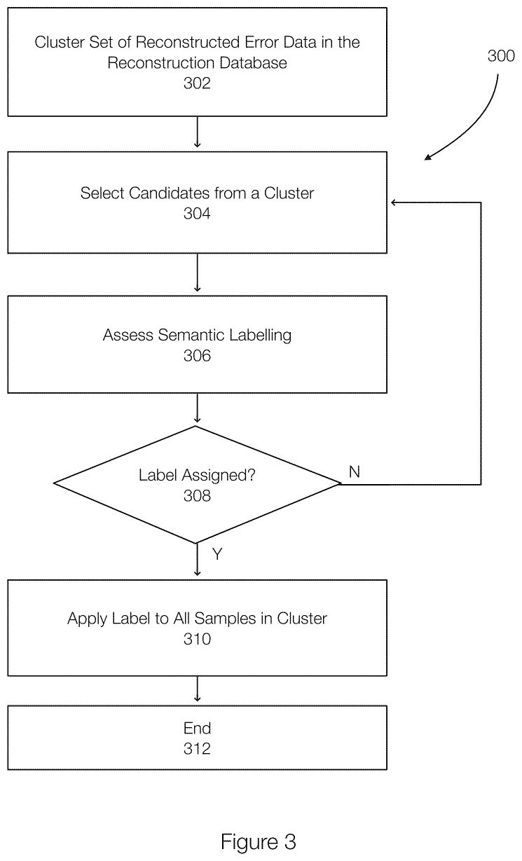

FIG. 3 discloses aspects of semantic labelling of reconstruction error vector clusters. As previously stated, each reconstruction error sample may be an n-dimensional vector. Embodiments of the invention cluster these reconstruction error vectors in a manner that allows events to be detected using the autoencoder. More specifically, when the autoencoder yields a reconstruction vector with errors, the input data is not normative. However, there are innumerous kinds of errors. A set of inputs that is consistently reconstructed with a systematic error may reflect the same kind of never-before-seen event. Clustering the reconstruction error vectors or samples may allow these reconstruction error samples (and the corresponding input data samples) to be labelled.

In the method 300, samples from the reconstruction database, which stores reconstruction error samples or vectors, are clustered 302 using a clustering algorithm. Next, candidate samples from a cluster are selected 304. Semantical labelling is performed 306 for each of the candidate samples. If a label is assigned (Y at 308) to all of the candidate samples, the label is applied 310 to all reconstruction error samples in the same cluster. The process may end 312. If the same label is not assigned (N at 308) to all of the candidate samples, the method 300 may end. In one example, the label may be assigned at 308 by expert or other evaluator at least because this process is unsupervised learning and no contextual data is available in some instances. Candidate samples may be similarly evaluated from each of the clusters. This allows semantic labels to be associated with each of the clusters and each of the reconstruction error sample therein.

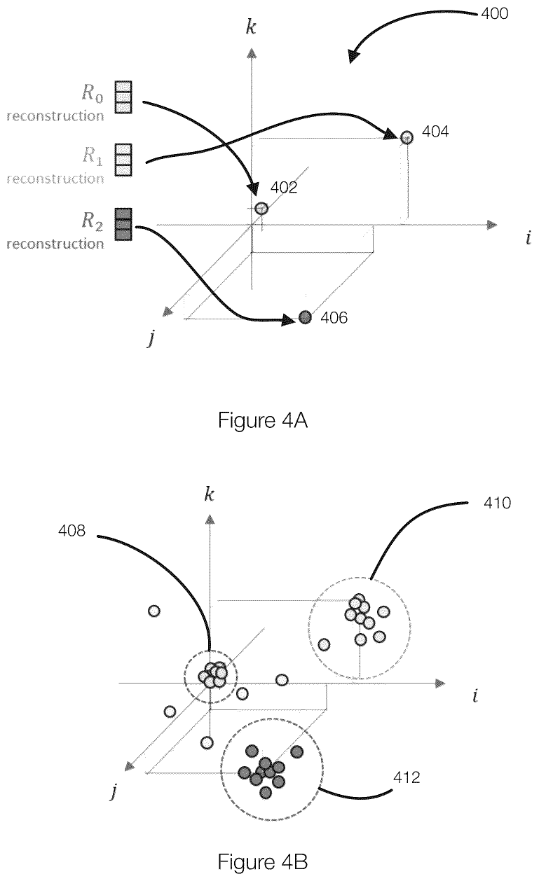

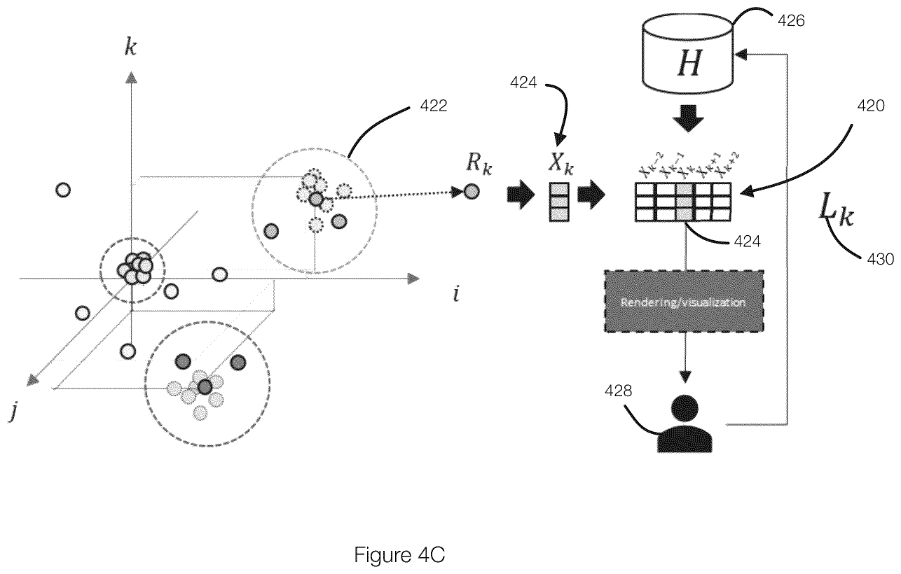

FIG. 4A discloses aspects of reconstruction error samples. FIG. 4A illustrates three reconstruction error samples or vectors: R₀, R₁, and R₂, which have corresponding errors E₀, E₁, and E₂ and which are labelled as errors 402, 404, and 406. The graph 400 may plot the errors in a feature-based manner. Each axis represents a feature (or dimension) of the reconstruction error sample or vector. In this example, the sample X₁ (corresponding to the reconstruction error sample R₁) is reconstructed with a larger error in features represented by axes k and i and with a smaller error in feature represented by axis j. The other vectors can be similarly interpreted.

FIG. 4B illustrates aspects of clustering reconstruction error samples when a sufficient number of samples exists. FIG. 4B illustrates clusters 408, 410, and 412. Outliers are also illustrated. When clustering, the number of clusters can be pre-defined. Alternatively, an algorithm may attempt to find a best number of clusters given the available samples.

A measure of cohesion, separation, and/or silhouette for each cluster can be defined in order to keep the best clusters. In one example, clusters near the origin may be discarded as them may represent normative events. Further, the distance of samples from a centroid of the cluster 408, which is near the origin, may be used to infer a threshold value for the autoencoder during an inference stage.

FIG. 4C discloses aspects of providing a label to samples represented in the clusters. In one example, candidate samples from the cluster 422 may be selected. The candidate samples may include p candidate samples closest to a centroid of the cluster 422 and q candidate samples farthest from the centroid. Alternatively, the candidate samples may include candidates selected at random.

FIG. 4C illustrates an example candidate sample 424 from the set of selected candidate samples. Once the candidate sample 424 is selected, contextual samples are retrieved from the database 426. In this example, contextual samples immediately preceding and/or following the data of the sample 424 may be retrieved from the database. This allows an evaluator 428 to have a better sense of the period in which the sample or event 424 occurred. The number of samples before/after the event can vary.

For example, in the domain of warehouse logistics, a dashboard in a user interface may illustrate a video replay, from security cameras, that includes the instant (time period) of the data 424. The evaluator 428 may provide a label 430 to the data or sample 424. This is performed when the evaluator 428 determines that the event of the sample 424 is semantically meaningful. For example, the evaluator 428 may label the sample 428 as a dangerous cornering event. More generally, the label may be applied to the input data samples, the output or reconstructed samples, and/or the reconstruction error samples.

If the label 430 is applied by the evaluator 428, the same label 430 is applied to all reconstruction error samples in the cluster 422. If no label is applied, the cluster 422 may be discarded. In one example, the evaluator 428 may evaluate all of the candidate samples. Further, before applying the label 430 to all of the samples in the cluster 422, the evaluator 428 must determine that all of the candidate samples represent the same event or have the same or sufficiently similar semantic meaning. In one example, all samples may be assigned the same label if a sufficient subset of the candidate samples are given the same label by the evaluator. A sufficient subset of may include more than 2% of the candidate samples, more than 5% of the candidate samples, more than 10% of the candidate samples, or the like. Embodiments are not limited to these ranges, which are given by way of example. In addition, the requirement may vary from one domain to another domain. In one example, this helps ensure that clusters represent similar, not necessarily identical, behavior.

The number of candidate samples selected may influence the accuracy of the label. A smaller set of candidate samples may be evaluated more expediently, but at a risk of assigning incorrect labels for events in a cluster that represent more than one relevant event in the domain. This process reduces the amount of human effort required to annotate large volumes of data.

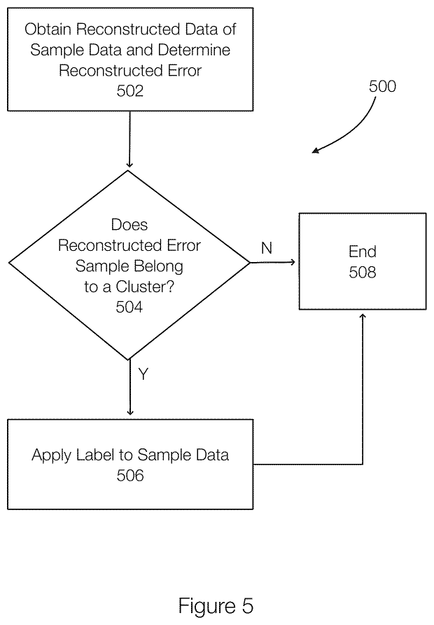

FIG. 5 discloses aspects of inferring labels using labels applied to reconstruction error samples. In this example, the model or autoencoder may be deployed to nodes in the environment. When an autoencoder receives an input data or data sample, a reconstructed sample or data may be obtained 502 as output of the autoencoder. The reconstruction error sample or vector is determined from the input and reconstructed samples.

The method 500 then determines whether the reconstruction error sample belongs to one of the clusters that were generated from historical samples. If the reconstruction error sample belongs to a cluster (Y at 504), the label that has been associated to that cluster is applied 506 to the input sample (or to the reconstruction error sample) and the method 500 ends 508. If the reconstruction error sample does not belong to a cluster (N at 504) the reconstruction error sample may be discarded. The method then ends 508.

Even if the input sample is not labeled, the input sample may still be stored in a sample database and may be labeled in subsequent operations on the historical database as described herein. During a re-clustering operation, for example, the unlabeled data may correspond to a cluster and be amenable to labelling.

To determine whether the input sample or its reconstruction error sample belong to a cluster, m reconstruction error samples are selected from the cluster and their distances to the centroid of the cluster are determined. If the distance of the reconstructed sample error being evaluated is smaller than the mean distance, the reconstruction error sample likely belongs to the cluster. When the reconstruction error sample belongs to the cluster (Y at 504), the label determined for that cluster is applied to the reconstruction error sample or to the corresponding input data sample. Further, this may allow a decision to be performed at the node. If the label is dangerous cornering, for example, corrective action may be performed at the node.

If the compute resources of the node are insufficient, these operations may be performed at the near edge node, although this may introduce a delay.

As previously discussed, decisions based on the output of an autoencoder typically rely on a threshold value. When determining whether a reconstruction error sample belongs to a cluster, a distance of samples to the centroid can be used. Similarly, the distance of samples with respect to a centroid of a cluster around or near the origin (normative samples) may be used to infer a threshold value.

Embodiments of the invention advantageously allow an inferencing state that can determine whether a sample belongs to a semantically relevant cluster and, for which a label can be applied automatically. Further, embodiments of the invention may automatically determine a threshold value for anomalous events without human input.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, machine learning operations, autoencoder operations, clustering operations, labelling operations, or the like.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers or VMs, or any combination of these, though no particular device implementation or configuration is required for any embodiment.

Example embodiments of the invention are applicable to any system capable of storing and handling various types of objects, in analog, digital, or other form. The principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method comprising: obtaining a database of reconstruction error vector samples, clustering the reconstruction error vector samples sampled from said database into clusters of reconstruction error vector samples, selecting candidate samples from a first cluster included in the clusters, assigning a label to each of the candidate samples, and applying the label to all reconstruction error vector samples in the first cluster when the labels assigned to a sufficient subset of the candidate samples is the same.

Embodiment 2. The method of embodiment 1, further comprising collecting data samples from multiple nodes operating in an environment and storing the data samples in a sample database, wherein the data samples are associated to the reconstruction error vector samples.

Embodiment 3. The method of embodiment 1 and/or 2, further comprising generating the reconstruction error vector samples from data samples using an unsupervised autoencoder.

Embodiment 4. The method of embodiment 1, 2, and/or 3, wherein the reconstruction error vector samples are generated as an absolute element-wise difference between data samples input into the unsupervised encoder and reconstruction samples output from the unsupervised autoencoder.

Embodiment 5. The method of embodiment 1, 2, 3, and/or 4, further comprising retrieving context samples from the data samples for each of the candidate samples, wherein the context samples occur immediately before and/or after the corresponding candidate sample.

Embodiment 6. The method of embodiment 1, 2, 3, 4, and/or 5, further comprising considering the context samples associated to the candidate samples when assigning labels to the candidate samples.

Embodiment 7. The method of embodiment 1, 2, 3, 4, 5, and/or 6, further comprising deploying an autoencoder to nodes in an environment.

Embodiment 8. The method of embodiment 1, 2, 3, 4, 5, 6, and/or 7, further comprising: generating, by the autoencoder operating on a node, a first reconstructed sample output from a first data sample input to the autoencoder, generating a first reconstruction error vector sample from the data sample input and the reconstructed sample output, determining whether the first reconstruction error vector sample belongs in the first cluster, and applying the label associated with the reconstruction error samples in the first cluster to the first reconstruction error sample.

Embodiment 9. The method of embodiment 1, 2, 3, 4, 5, 6, 7, and/or 8, further comprising automatically determining a threshold value for an autoencoder based on a distance of reconstruction error vector samples from a centroid of a cluster near an origin of a cluster space.

Embodiment 10. A method comprising: generating, by an autoencoder deployed at a node operating in an environment, a reconstructed output from a sample input to the autoencoder, generating a reconstruction error sample from the sample input and the reconstructed output, determining whether the reconstruction error sample belongs in the first cluster, wherein the first cluster is included in a plurality of clusters, wherein each of the plurality of clusters includes reconstruction error samples that are labeled with the same label, and applying the label associated with the first cluster to the reconstruction error sample.

Embodiment 11. The method of embodiment 10, further comprising clustering reconstruction error samples associated with data samples that have been processed by an autoencoder into clusters and labelling each of the reconstruction error samples in each of the clusters based on labels assigned to candidate samples from each of the clusters.

Embodiment 12. The method of embodiment 10 and/or 11, further comprising performing an action when an output of the autoencoder is non-normative and below a threshold value that is determined automatically from a cluster of reconstruction error samples near an origin of a cluster space.

Embodiment 14. A method for performing any of the operations, methods, or processes, or any portion of any of these, or any combination thereof disclosed herein.

Embodiment 15. A non-transitory storage medium having stored therein instructions that are executable by one or more hardware processors to perform operations comprising the operations of any one or more of embodiments 1-14.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, engine, or agent may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

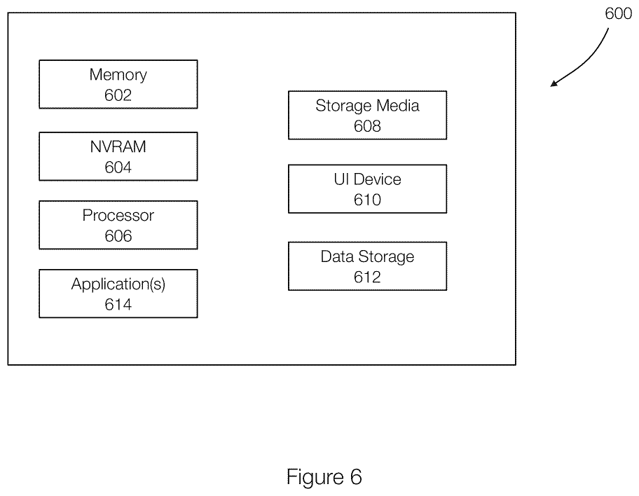

With reference briefly now to FIG. 6, any one or more of the entities disclosed, or implied, by the Figures, and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 602 of the physical computing device 600 may take the form of solid-state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
obtaining a database of reconstruction error vector samples;
clustering the reconstruction error vector samples sampled from said database into clusters of reconstruction error vector samples;
selecting candidate samples from a first cluster included in the clusters;
assigning a label to each of the candidate samples; and
applying the label to all reconstruction error vector samples in the first cluster when the label assigned to a sufficient subset of the candidate samples is the same.

2. The method of claim 1, further comprising collecting data samples from multiple nodes operating in an environment and storing the data samples in a sample database, wherein the data samples are associated to the reconstruction error vector samples.

3. The method of claim 2, further comprising generating the reconstruction error vector samples from the data samples using an unsupervised autoencoder.

4. The method of claim 3, wherein the reconstruction error vector samples are generated as an absolute element-wise difference between data samples input into an unsupervised encoder and reconstruction samples output from the unsupervised autoencoder.

5. The method of claim 1, further comprising retrieving context samples from data samples for each of the candidate samples, wherein the context samples occur immediately before and/or after the corresponding candidate sample.

6. The method of claim 5, further comprising considering the context samples associated to the candidate samples when assigning labels to the candidate samples.

7. The method of claim 1, further comprising deploying an autoencoder to nodes in an environment.

8. The method of claim 7, further comprising:
generating, by the autoencoder operating on a node, a first reconstructed sample output from a first data sample input to the autoencoder;
generating a first reconstruction error vector sample from the data sample input and the reconstructed sample output;
determining whether the first reconstruction error vector sample belongs in the first cluster; and
applying the label associated with the reconstruction error samples in the first cluster to the first reconstruction error sample.

9. The method of claim 1, further comprising automatically determining a threshold value for an autoencoder based on a distance of reconstruction error vector samples from a centroid of a cluster near an origin of a cluster space.

10. A non-transitory storage medium having stored therein instructions that are executable by one or more hardware processors to perform operations comprising:
obtaining a database of reconstruction error vector samples
clustering the reconstruction error vector samples sampled from said database into clusters of reconstruction error vector samples;
selecting candidate samples from a first cluster included in the clusters;
assigning a label to each of the candidate samples; and
applying the label to all reconstruction error vector samples in the first cluster when the label assigned to a sufficient subset of the candidate samples is the same.

11. The non-transitory storage medium of claim 10, further comprising collecting data samples from multiple nodes operating in an environment and storing the data samples in a sample database.

12. The non-transitory storage medium of claim 11, further comprising generating the reconstruction error vector samples from the data samples using an unsupervised autoencoder.

13. The non-transitory storage medium of claim 12, wherein the reconstruction error vector samples are generated as an absolute element-wise difference between data samples input into an unsupervised encoder and reconstruction samples output from the unsupervised autoencoder.

14. The non-transitory storage medium of claim 10, further comprising retrieving context samples from data samples for each of the candidate samples, wherein the context samples occur immediately before and/or after the corresponding candidate sample.

15. The non-transitory storage medium of claim 14, further comprising considering the context samples associated to the candidate samples when assigning labels to the candidate samples.

16. The non-transitory storage medium of claim 10, further comprising:
deploying an autoencoder to nodes in an environment;
generating, by the autoencoder operating on a node, a first reconstructed sample output from a first data sample input to the autoencoder;
generating a first reconstruction error vector sample from the data sample input and the reconstructed sample output;
determining whether the first reconstruction error vector sample belongs in the first cluster; and
applying the label associated with the reconstruction error samples in the first cluster to the first reconstruction error sample.

17. The non-transitory storage medium of claim 10, further comprising automatically determining a threshold value for an autoencoder based on a distance of reconstruction error vector samples from a centroid of a cluster near an origin of a cluster space.

18. A method comprising:
generating, by an autoencoder deployed at a node operating in an environment, a reconstructed output from a sample input to the autoencoder;
generating a reconstruction error sample from the sample input and the reconstructed output;
determining whether the reconstruction error sample belongs in a first cluster, wherein the first cluster is included in a plurality of clusters, wherein each of the plurality of clusters includes reconstruction error samples that are labeled with the same label; and
applying the label associated with the first cluster to the reconstruction error sample.

19. The method of claim 18, further comprising clustering reconstruction error samples associated with data samples that have been processed by an autoencoder into clusters and labelling each of the reconstruction error samples in each of the clusters based on labels assigned to candidate samples from each of the clusters.

20. The method of claim 18, further comprising performing an action when an output of the autoencoder is non-normative and below a threshold value that is determined automatically from a cluster of reconstruction error samples near an origin of a cluster space.
